(19) United States
(12) Patent Application Publication
(10) Pub. No.: US 2026/0050477 A1
(43) Pub. Date: Feb. 19, 2026

(54) ANONYMOUS CENTRALIZED TRANSFER OR ALLOCATION OF RESOURCE

(71) Applicant: ESH OS LTD., Giv'atayim (IL)

(72) Inventors: Yuval ALONI, Kiryat Tivon (IL); Alex LIVERANT, Giv'atayim (IL); Shir RAANAN, Kfar Haim (IL); Shmuel UR, Shorashim (IL)

(73) Assignee: ESH OS LTD., Giv'atayim (IL)

(21) Appl. No.: 19/101,630

(22) PCT Filed: Aug. 2, 2023
(86) PCT No.: PCT/IL2023/050801

§ 371 Date: Feb. 6, 2025

Related U.S. Application Data
(60) Provisional application No. 63/396,038, filed on Aug. 8, 2022.

(51) Int. Cl. G06F 9/50

(52) U.S. Cl. CPC G06F 9/5027

(57) ABSTRACT

Systems and methods for centralized transfer or allocation of resources may include receiving a first set of data describing a plurality of providing entities and an associated number of units of a resource which are available for allocation; receiving a second set of data describing a resource request associated with a requesting entity; assessing the resource request according to a set of predefined allocation criteria; determining at least two providing entities for which the resource request satisfies the set of predefined allocation criteria; and dividing the resource request across the determined set of providing entities in accordance with a fairness criterion.

### FIELD OF THE INVENTION

The invention relates generally to allocation or transfer of resources, for example the allocation of computing resources.

### BACKGROUND

Many individuals and organizations possess resources, such as computing resources, which they manage, such as in the context of a private cloud, or a network of computers. Such resources may be processing bandwidth or time, memory or other storage, computer network bandwidth, or in other contexts physical items (e.g. goods), or financial related resources. Often, they do not need all the resources that they have, and sometimes they require more than what are currently in their possession. If they were able to trade those computing resources, for example making computing resources available to others when they have less need of the resources themselves, or obtaining more computing resources when they have a greater need for computing power, then this would be advantageous. Resource transfer in other contexts may take place.

### SUMMARY

Advantages and improvements of the invention may include sharing of underutilized resources.

According to one or more embodiments, there is provided a computer implemented method of centralized allocation of resources, the method including: receiving a first set of data describing a plurality of providing entities and an associated first number of units of a resource which are available for allocation belonging to a corresponding providing entity; receiving a second set of data describing a resource request associated with a requesting entity, wherein the resource request includes a requested number of units of the resource; assessing the resource request according to a set of predefined allocation criteria predefined for each of the plurality of providing entities, wherein the set of predefined allocation criteria includes at least one of: a geographic location of the requesting entity; a risk level of the requesting entity; an industry or other attribute of the requesting entity; and an allocation time period; determining a set of at least two providing entities for which the resource request satisfies the set of predefined allocation criteria of said at least two providing entities; dividing the resource request across the determined set of providing entities in accordance with a fairness criterion; recording, in a third set of data, a second number of units of the resource to be transferred from each of said at least two providing entities; sending, to a computing device of the requesting entity, a fourth set of data describing a transfer of the requested number of units of the resource; receiving, from the computing device of the requesting entity, at a predetermined time, a fifth set of data describing a third number of units of the resource to be distributed among the set of at least two providing entities; and sending, to a computing device of each providing entity of the determined set of at least two providing entities, a sixth set of data describing a transfer of a fourth number of units of the resource in accordance with the set of predefined allocation criteria and the fairness criterion.

According to some embodiments, neither the at least two providing entities contributing to the resource request, nor the requesting entity from which the resource request was received are aware of the involvement of any of the other entities in the resource request.

According to some embodiments, a same providing entity contributes units of the resource to more than one resource request.

According to some embodiments, the fairness criterion takes into account at least one of: an attribute of the providing entity; or one or more previous contributions of the providing entity to one or more previous resource requests.

According to some embodiments, the resource is one of computer resources, seeds, energy, or money.

According to some embodiments, the method further includes receiving, from a computing device of a providing entity contributing to a resource request, a seventh set of data describing a request to stop the allocation of its resources and take back the providing entity's contribution to the resource request; determining at least one new providing entity for which the resource request satisfies a set of predefined allocation criteria of the at least one new providing entity; and generating an eighth set of data describing a transfer of the contribution to the resource request from the withdrawing providing entity to the at least one new providing entity.

According to one or more embodiments, a system for centralized allocation of resources includes: at least one processor; and a memory containing one or more sets of instructions which, when executed, cause the at least one processor to: receive a first set of data describing a plurality of providing entities and an associated first number of units of a resource which are available for allocation belonging to a corresponding providing entity; receive a second set of data describing a resource request associated with a requesting entity, wherein the resource request includes a requested number of units of the resource; assess the resource request according to a set of predefined allocation criteria predefined for each of the plurality of providing entities, wherein the set of predefined allocation criteria includes at least one of a: a geographic location of the requesting entity; a risk level of the requesting entity; an industry or other attribute of the requesting entity; and an allocation time period; determine a set of at least two providing entities for which the resource request satisfies the set of predefined allocation criteria of said at least two providing entities; divide the resource request across the determined set of providing entities in accordance with a fairness criterion; record, in a third set of data, a second number of units of the resource to be transferred from each of said at least two providing entities; send, to a computing device of the requesting entity, a fourth set of data describing a transfer of the requested number of units of the resource; receive, from the computing device of the requesting entity, at a predetermined time, a fifth set of data describing a third number of units of the resource to be distributed among the set of at least two providing entities; and send, to a computing device of each providing entity of the determined set of at least two providing entities, a sixth set of data describing a transfer of a fourth number of units of the resource in accordance with the set of predefined allocation criteria and the fairness criterion.

According to some embodiments, the processor is configured to ensure that neither the at least two providing entities contributing to the resource request, nor the requesting entity from which the resource request was received are aware of the involvement of any of the other entities in the resource request.

According to some embodiments, the processor is configured to record when a same providing entity contributes units of the resource to more than one resource request.

According to some embodiments, the fairness criterion takes into account at least one of: an attribute of the providing entity; or one or more previous contributions of the providing entity to one or more previous resource requests.

According to some embodiments, the resource is one of computer resources, seeds, energy, or money.

According to some embodiments, the processor is configured to: receive, from a computing device of a providing entity contributing to a resource request, a seventh set of data describing a request to stop the allocation of its resources and take back the providing entity's contribution to the resource request; determine at least one new providing entity for which the resource request satisfies a set of predefined allocation criteria of the at least one new providing entity; and generate an eighth set of data describing a transfer of the contribution to the resource request from the withdrawing providing entity to the at least one new providing entity.

According to one or more embodiments, there is provided a computer implemented method of transfer of assets including: receiving a plurality of first data sets, each first data set describing a providing entity and an associated first number of assets which are available for transfer; receiving a second set of data describing a request associated with a requesting entity, wherein the request includes a requested number of assets; identifying at least two providing entities for which the request satisfies a set of predefined transfer criteria selected by said at least two providing entities; dividing the request across the identified at least two providing entities equally, or according to the first number of assets of each of said at least two providing entities; recording, in a third set of data, a second number of assets to be transferred from each of said at least two providing entities; and sending, to a computing device of the requesting entity, a fourth set of data describing a transfer of the requested number of assets.

According to some embodiments, the method includes: receiving, from the computing device of the requesting entity, at a predetermined time, a fifth set of data describing a third number of assets to be distributed among the identified at least two providing entities; and sending, to a computing device of each of said identified at least two providing entities, a sixth set of data describing a transfer of a fourth number of assets in accordance with the set of predefined allocation criteria and the fairness criterion.

According to some embodiments, neither the identified at least two providing entities, nor the requesting entity from which the request was received are aware of the involvement of any of the other entities in the request.

According to some embodiments, a same providing entity contributes a number of assets to more than one request.

According to some embodiments, the set of transfer criteria comprises at least one of: a geographic location of the requesting entity; a risk level of the requesting entity; an industry or other attribute of the requesting entity; and a predetermined time period after which the assets are to be transferred back.

According to some embodiments, dividing the request across the identified at least two providing entities according to the first number of assets of each of said at least two providing entities takes into account at least one of: an attribute of the providing entity; or one or more previous contributions of the providing entity to one or more previous requests.

According to some embodiments, the asset is one of computer resources, seeds, energy, or money.

According to some embodiments, the method includes receiving, from a computing device of a providing entity contributing to a request, a seventh set of data describing a request to stop and take back the transfer of the providing entity's contribution to the resource request; determining at least one new providing entity for which the request satisfies a set of predefined transfer criteria of the at least one new providing entity; and generating an eighth set of data describing a transfer of the contribution to the request from the withdrawing providing entity to the at least one new providing entity.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, may be understood by reference to the following detailed description when read with the accompanying drawings. Embodiments are illustrated without limitation in the figures, in which like reference numerals indicate corresponding, analogous, or similar elements, and in which:

FIG. 1 is a block diagram of a computing device, according to some embodiments of the invention;

FIG. 2 is a flowchart of a method, according to some embodiments of the invention

FIG. 3 is a flowchart depicting an algorithm, according to some embodiments of the invention;

FIG. 4 is a flowchart depicting an algorithm, according to some embodiments of the invention;

FIG. 5 is a flowchart depicting an algorithm, according to some embodiments of the invention;

FIG. 6 is a flowchart depicting an algorithm, according to some embodiments of the invention; and

FIG. 7 is a block diagram of a system, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

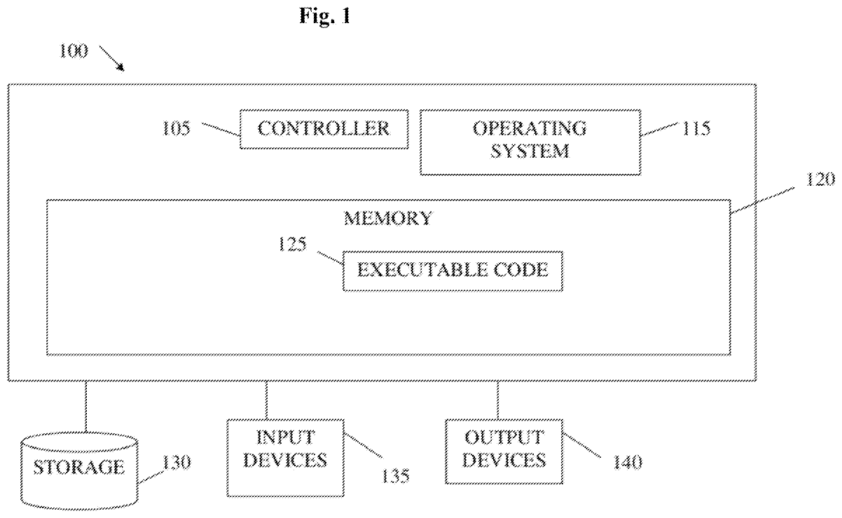

FIG. 1 shows a block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. At least a portion of Memory 120 may include data storage housed online on the cloud. Memory 120 may be or may include a plurality of different memory units. Memory 120 may store for example, instructions (e.g. code 125) to carry out a method as disclosed herein. Memory 120 may use a datastore, such as a database.

Executable code 125 may be any application, program, process, task, or script. Executable code 125 may be executed by controller 105 possibly under control of operating system 115. For example, executable code 125 may be, or may execute, one or more applications performing methods as disclosed herein, such as a machine learning model, or a process providing input to a machine learning model. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105. Storage 130 may include cloud storage. Storage 130 may include storing data in a database.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

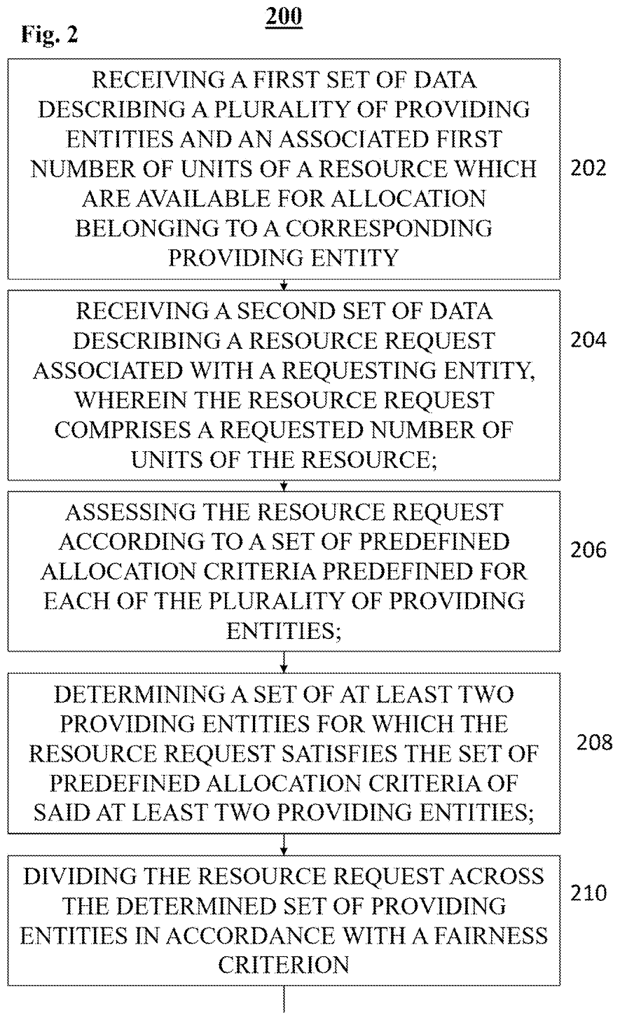

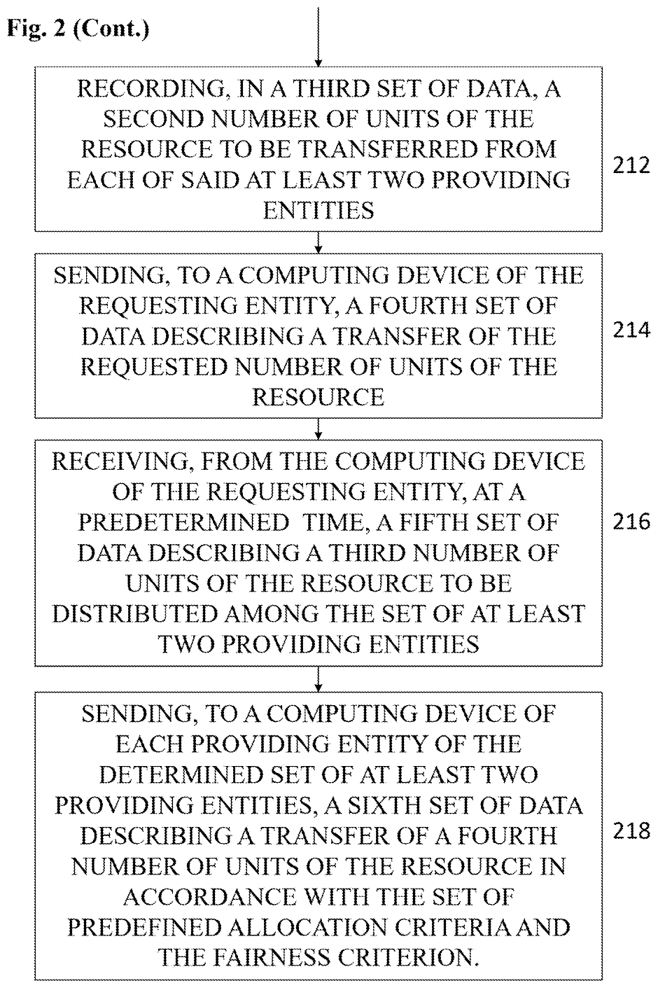

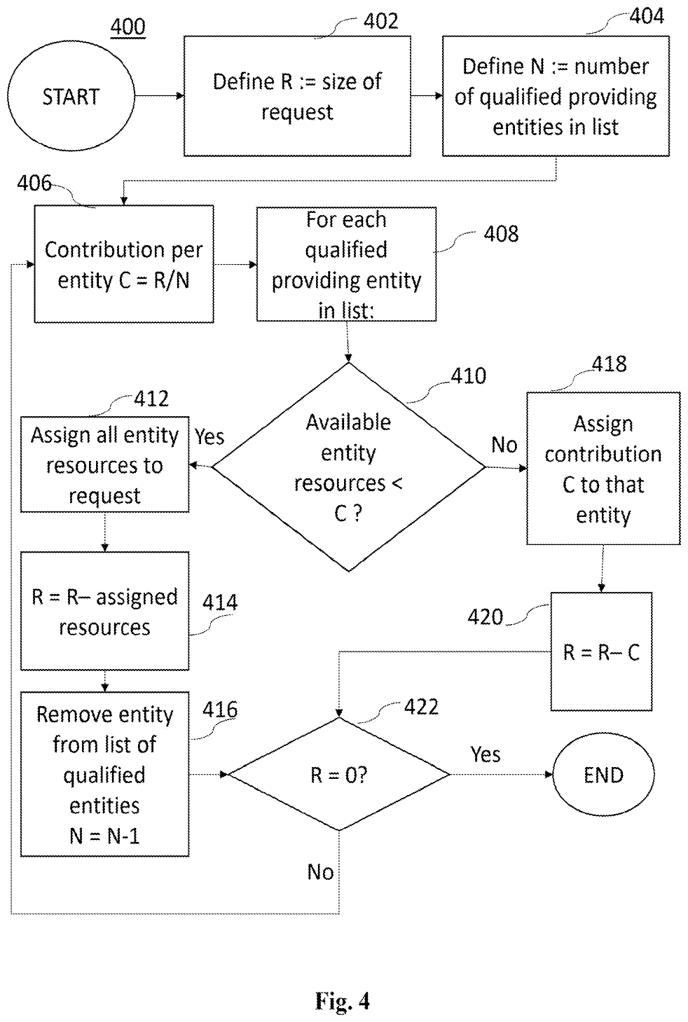

FIG. 2 shows a flowchart of an example method 200, according to some embodiments of the invention. Method 200 may be implemented by a computer and other equipment, such as computing device 100 shown in FIG. 1 and the equipment shown in FIG. 4, or by other systems. Method 200 may include the transfer or allocation of resources or assets between one or more computing devices of one or more entities, managed by a computing device of a central entity. Entity may be used herein to refer to a natural or legal person, such as an individual or organization, or a computing device associated with, e.g. owned and or operated by, a natural or legal person.

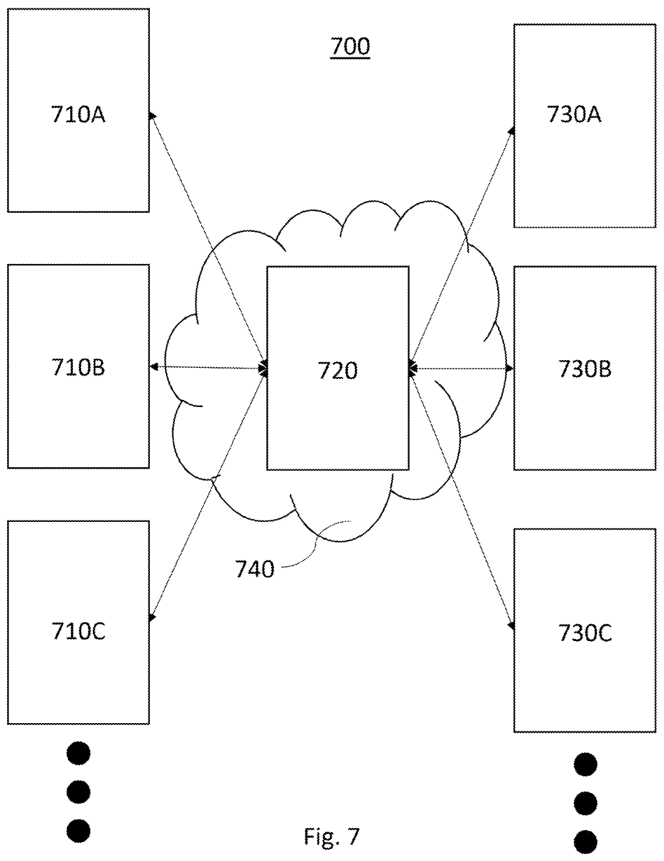

A central entity may be an organization which oversees the transfer or allocation of resources. In some embodiments the central entity may act like a “bank” for the allocation and transfer of the resource, and in some embodiments may be a bank. In embodiments where the central entity is a bank, or other financial institution, allocation of resources/assets may involve loaning the resources, for example a financial loan of money. A central entity may be associated with a computing device, such as computing device 720 of FIG. 7, which may be referred to as a central load manager, or simply load manager.

A providing entity may be an individual or organization which has resources/assets available to transfer or allocate, or a device or system. For example, a providing entity may be a server or data center having computer resources to transfer or allocate, or the organization operating such a server or data center. In some embodiments, for example where the resource is a physical resource such as seeds, the providing entity may transfer the resources/assets it has available to allocate to the central entity. In some embodiments, for example where the resource is energy such as electricity, the central entity may be an owner/operator of an electrical network, such as an electric grid. A providing entity may predefine criteria about the types of entities it is willing to allocate or transfer its resources to. The central entity may receive these criteria.

A requesting entity may be an individual or organization which requires resources/assets. A requesting entity may submit a resource request to the central entity (e.g. provide data describing a request for resources). The central entity may assess the request based on the predefined criteria determined by itself, or provided by the providing entity to determine if to make resources available to the requesting entity.

Method 200 may include receiving (202) a first set of data (data e.g. in a JavaScript Object Notation “JSON” file, extensible mark-up language “XML” file, or Excel spreadsheet “XLS” file) describing a plurality of providing entities and an associated first number of units or amount of a resource which are available for allocation or transferring and belonging to a corresponding providing entity. In some embodiments, a plurality of first data sets are received, each first data set describing a providing entity and an associated first number of assets which are available for transfer. The first set of data may be received from a computing device associated with (e.g. operated by) the providing entities. The computing devices may be similar to computing devices 100 as shown in FIG. 1. The first set of data may list an owner and an amount or number of resources or assets, such as computing resources, which the owner of the resources is willing or able to make available for others to use. A number of units of the resource which are available for allocation may include a number of machines, such as a number of server computers and/or a number of virtual machines, an amount of memory, an amount of network bandwidth, etc. which are available for others to use.

The resource may be for example computing resources, seeds, energy (e.g. electricity), money, or any other resource transferred among entities (e.g. among computing systems, people, organizations, etc.). A unit of a resource may be a quantized measure of the resource. For example, when the resource is computing resources, a unit of the resource may be represented by 1 Gb of computing power, or 1 hour of computing time, or 1 server computer available for use. In embodiments where the resource is money, a unit of the resource may be a monetary amount of a currency, such as US dollars, Great British pounds, or Euros. Allocating or transferring may include lending, e.g. lending in a financial context, or lending computing or other resources with the understanding that some version of those resources will be transferred back or paid back at a later time. In embodiments where the resource is seeds, one unit may represent 1 seed, and it will be understood that in certain cases such as seeds such units cannot be sub-divided. Other resources may be allocated.

The first set of data may be received and/or updated by a central entity (such as load manager 720 in FIG. 7) as and when new providing entities make resources available for the first time and/or when previously known providing entities make more units of the resource available for allocation.

Method 200 may include receiving (204), e.g. at the central entity, a second set of data describing a resource request (or simply “request” as also used herein) associated with a requesting entity. The resource request and/or the data describing the resource request may include a requested number of assets or number of units of the resource. The data describing the resource request may be received from a computing device of, e.g. operated by, the requesting entity. In some embodiments, the resource request and/or the data describing the resource request may include an expected time frame or period for which the units of the resource are expected to be required.

In embodiments where the resource is computing resources, a requested number of units of the resource may include for example a number of machines and types which may be implemented by virtual machines, and how much time is needed on each, or another request description such as an amount of memory, bandwidth, etc. For example, a resource request may describe a particular type of computer processing unit (CPU) and associated cache, as well as describing that ten batches of half an hour, and one batch of 15 minutes is required. Different types of real CPU and cache can be converted into virtual machines using methods known in the art. Converting the resources for use by virtual machines may make remote access to the resources easier, and may help partition the physical resources and prevent unauthorized access to data stored thereon.

Method 200 may include assessing (206), e.g. by the central entity, the resource request according to a set of predefined allocation or transfer criteria predefined for each of the plurality of providing entities. The assessing may be performed by one or more specific algorithms executed on a computing device. Assessing may include accepting or denying the resource request. In embodiments where the resource is computing resources, assessing the resource request may include determining if available resources can be converted to a virtual machine satisfying the needs of the requesting entity, e.g. a number of units of the resource which are available for allocation may be checked against possible translations into a virtual machine and the specifications of the resulting translated virtual machine may be compared against the requested number of units of the resource to see if the virtual machine fulfills the requirements of the request.

The predefined transfer or allocation criteria may describe one or more desired attributes which the providing entity requires the requesting entity to satisfy in order to make resources available to the requesting entity. According to some embodiments, the set of predefined allocation criteria includes at least one of: a geographic location of the requesting entity; a risk level of the requesting entity; an industry or other attribute of the requesting entity; and/or an allocation time period.

For example, a geographic location of the requesting entity may relate to a country in which the requesting entity is resident or is registered as a business. If a providing entity requires a requesting entity to be registered in the United States of America, then a requesting entity which is registered in the United Kingdom would not satisfy, e.g. meet/match, this allocation criteria.

In another example, a risk level of the requesting entity may be determined, for example on the basis of an internal or external rating and/or score. A providing entity may predefine that they only wish to make their resources available to requesting entities with such specific external score (for example: Ebay seller score/Apple AppStore rating/FICO credit score) greater than 500 on a scale from 0 to 700. A requesting entity with a score of 550 would meet this criteria, but a requesting entity with a score of 300 would not. In some embodiments, risk is assessed qualitatively rather than quantitively, for example risk may be characterised in terms of low, medium, and high risk. A low risk may represent a low probability that the requesting entity will not return the resources, if requested during, or at the end of the allocation period, and a high risk may represent a high probability that the requesting entity will not return the resources, if requested during, or at the end of the allocation period. In embodiments where the resource is computing resources, risk may characterize the likelihood of the requesting entity not returning the computing resources, e.g. not relinquishing access to the computing resources. Risk may also characterize the likelihood of the requesting entity being unable (e.g. becoming insolvent or not having the resources available), or unwilling, to return a number of computing resources.

In another example, an industry of the requesting entity may include a business sector in which the requesting entity is principally involved, such as video streaming, digital marketing, electronic chip design, agriculture, energy, pharmaceuticals, green industries, transport, etc. A providing entity or the central entity may predefine that they only wish their resources to be allocated out to certain classes of organizations, e.g. green industries. Thus, a requesting entity which is involved in solar energy may satisfy this criteria, but a requesting entity involved in gas fracking may not.

In another example, any other attribute of the requesting entity which may be considered relevant for the allocation of resources may be included in the allocation criteria. For example, the size of the requesting entity may be of relevance to the providing entity: in some examples the providing entity may only wish for their resources to be allocated to SMEs (small-medium enterprises) and not to large established corporations.

In another example, an allocation time period may relate to a length of time which the requesting entity expects to need the resources for. A providing (or the central) entity may predefine that they only wish to allocate their resources (all or a part thereof) for 1 month. Thus, a requesting entity that requires resources for 1 year does not meet this criteria.

The data describing the resource request may be extracted from a standard form used for submitting all resource requests.

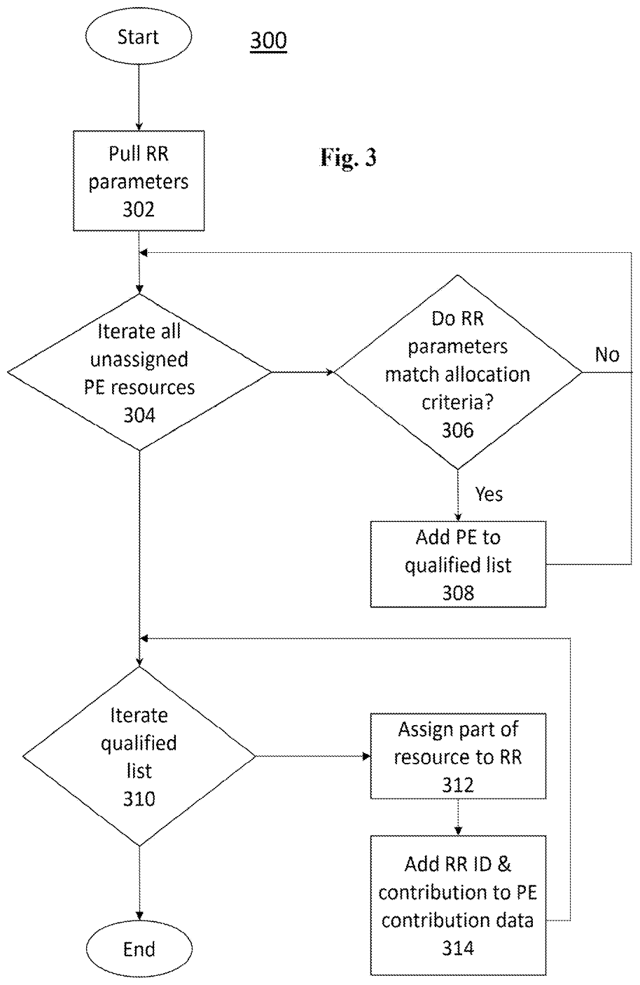

Method 200 may include identifying or determining (208) a set (e.g. a list) of at least two providing entities for which the resource request satisfies the set of predefined allocation criteria of said at least two providing entities. The determining may be performed at the same time as the assessing 206. Assessing may include denying the resource request if the requested number of units exceeds a total number of available units across all entities in the determined set; for example, if the requested number of units is 10,000 but the sum total of associated first number of units of the resource which are available for allocation belonging to the determined providing entities is only 8,000, then the resource request in whole or in part may be denied because there is an insufficient number of units among relevant providing entities available to fulfil the request. A providing entity in the determined set may be referred to as a “qualified” entity in the sense that they are a relevant entity for the request with predefined allocation criteria satisfied by the resource request. Determining a set/list of at least two qualified providing entities together with additional criteria of the central entity may distinguish embodiments of the invention from “peer-to-peer” schemes. As discussed above, the data describing the resource request may be directly compared to the predefined allocation criteria to determine whether the resource request meets the predefined criteria. FIG. 3 describes in detail below an example algorithm for determining a set/list of at least two qualified providing entities for which the resource request satisfies the set of predefined allocation criteria of the at least two providing entities.

According to some embodiments, the predefined transfer or allocation criteria are weighted such that some criteria are more influential in determining a set of appropriate providing entities than others. For example, an industry of a requesting entity may be more important to some providing or central entities than a geographic profile of the requesting entity. Thus, if a resource request satisfies the predefined allocation criteria of the providing or central entity for industry but not for geographic location, the providing entity may still be added to the set of providing entities for the resource request because this criteria is more valued by that providing and/or central entity.

Method 200 may include dividing (210) the resource request across the determined set of providing entities in accordance with a fairness criterion, for example as described in FIG. 4. The fairness criterion may include one or more measures for ensuring equitable distribution and transfer of resources from providing entities to requesting entities. The fairness criterion may for example correspond to dividing the resource request equally among the providing entities. For example, if a resource request requires 90 Gb of computing power and each of three determined providing entities A, B and C each have at least 30 Gb of computing power to provide, then the resource request may be divided equally among each of providing entities A, B and C such that A, B and C each contribute exactly 30 Gb of computing power to the resource request.

In some embodiments, the fairness criterion may take into account one or more attributes of the providing entity, for example its size or the quality of its resources. In some embodiments, the fairness criterion may correspond to a macro or global notion of fairness, for example fairness across multiple resource requests. In this way the fairness criterion may take into account one or more previous contributions of a providing entity to one or more previous resource requests. Accordingly, the fairness criterion may take into account at least one of: an attribute of the providing entity; and/or one or more previous contributions of the providing entity to one or more previous resource requests. For example, in the scenario described above, if providing entity C only has 20 Gb of resources available, but A and B each have 100 Gb available for allocation, then to fulfil the resource request for 90 Gb the resource request may be divided as follows: C will contribute all of their 20 Gb, and the remaining 70 Gb is divided among A and B so that A and B each contribute 35 Gb. These differences may be noted in association with the providing entities, for example, in data stored in a database such as storage 130 shown in FIG. 1, and in future resource requests these differences may be taken into account. FIG. 4 describes in detail below an example algorithm for dividing the resource request across the determined set of providing entities in accordance with the fairness criterion.

Method 200 may include recording or storing (212), in a third set of data, a second number of units of the resource to be transferred from each of said at least two providing entities. For example, if a providing entity provided 100 units of the resource (e.g. 100 Gb of computing power) and contributed 60 units to a resource request, then the third set of data may record that the providing entity provided 60 units of resource towards the resource request. The first set of data may be updated to describe that the providing entity has 40 units of resource remaining which can be contributed to other resource requests.

Method 200 may include sending (214), to a computing device of the requesting entity, a fourth set of data describing a transfer of the requested number of units of the resource. The data describing the transfer may describe how the requested number of units of the resource are now available for use by the requesting entity. In one embodiment the data describing the transfer may not identify the set of two or more providing entities which contributed to the resource request, thereby maintaining a level of anonymity as to the parties involved in the resource request.

Method 200 may include receiving (216), from the computing device of the requesting entity, at a predetermined time, a fifth set of data describing a third number of units of the resource to be distributed among the set of at least two providing entities. The predetermined time may be a predetermined later time, for example corresponding with an allocation period. For example, if the resource request stipulated that the resources were required for 6 months, then after 6 months the requesting entity may send resources from its computing device. The resources received may include returned resources, or may include resources which are different to those contributed to the resource request (for example in embodiments where the resource is non-fungible). The third number of units of the resource received may include more units than were originally provided under the resource request. These additional units may be divided fairly (e.g. in accordance with the fairness criterion) among the providing entities who contributed to the resource request.

Method 200 may include sending (218), to a computing device of each providing entity of the determined set of at least two providing entities, a sixth set of data describing a transfer of a fourth number of units of the resource in accordance with the set of predefined allocation criteria and the fairness criterion. This fourth number of units may include any additional units received at 216, e.g. in addition to what was described in the fourth data set at 214.

In some embodiments, the fourth number of units has had subtracted therefrom a commission. The commission may be different for different providing entities, for example the commission may be proportional to a number of resources provided by the providing entity. In embodiments where the resource is computing resources, a commission of computing resources may be used for computations required by embodiments of the invention.

In some embodiments, method 200 is performed such that neither the at least two providing entities contributing to the resource request, nor the requesting entity from which the resource request was received are aware of the involvement of any of the other entities in the resource request. In other words, the allocation of resources may be anonymous: the requesting entity does not know who has provided the resources, and a providing entity does not know who they are providing resources to or the identity (or number) of any other providing entities also contributing resources to the same requesting entity. In some embodiments, the providing entity may only be aware (e.g. based on the data provided to them) that their resources have been allocated to an entity satisfying their allocation criteria, for example the providing entity may only be aware that 100 units of their resources were allocated to a medium risk pharmaceutical company in India who require the resources for 7 months, but may not be made aware of the name or address of the company.

According to some embodiments, a same providing entity contributes to more than one resource request. For example, if the first set of data describes that the providing entity has 500 units of the resource available for allocation, then the providing entity could contribute to two resource requests that satisfy the predefined allocation criteria and request 100 and 200 units of resources respectively.

FIG. 3 is a flowchart depicting an algorithm 300, according to some embodiments of the invention, for determining a set of at least two qualified providing entities.

According to some embodiments, algorithm 300 includes pulling (302), e.g. from a database such as storage 130, resource request (abbreviated “RR” in the Figure) parameters. The resource request parameters may include data describing the resource request, such as the information included in the second set of data of method 200 describing the resource request.

According to some embodiments, algorithm 300 includes iterating (304) on all unassigned providing entity (abbreviated “PE” in the Figure) resources. An unassigned providing entity resource may be for example, a number of units of a resource transferred to a central entity which are available for allocation, as described, for example, in the first set of data of method 200. A portion of the resources may be unassigned in the sense that they have not yet been contributed, allocated, or transferred to a requesting entity.

According to some embodiments, algorithm 300 includes querying (306) if the resource request parameters match the predefined allocation criteria of the providing entity being considered in the iteration loop. For example, algorithm 300 may compare resource request parameters against predefined allocation criteria and check that at least one parameter value of the resource request is equal to a corresponding allocation criteria. As discussed above, allocation criteria may be weighted (e.g. ranked or have an assigned priority) and algorithm 300 may only consider the resource request to satisfy the predefined allocation criteria if a sufficient number (e.g. a predefined threshold amount) of matches are identified.

If the answer at 306 is no, and the resource request parameters do not match the predefined allocation criteria of the providing entity being considered, then algorithm 300 may move on to the next unassigned resource in the iteration loop.

If the answer at 306 is yes, and the resource request parameters do match the predefined allocation criteria of the providing entity being considered, the providing entity may be added (308) to a qualified list. The qualified list may be a list or set of qualified providing entities, e.g. those providing entities for which the resource request satisfies the predefined allocation criteria of the providing entities on the list.

According to some embodiments, algorithm 300 includes iterating (310) on the qualified list. For example, algorithm 300 may consider each qualified providing entity and the portion of their corresponding resources which are unassigned.

According to some embodiments, algorithm 300 includes assigning/allocating (312) at least part of the providing entity's resources to the resource request. The assigning (e.g. determining the exact amount to be contributed) may be performed using a different algorithm, for example algorithm 400 described with reference to FIG. 4.

According to some embodiments, algorithm 300 includes adding (314) the resource request ID and contribution to the providing entity contribution data. A resource request ID may be a unique number identifying the resource request, and may be generated and/or assigned by the central entity upon receipt of a new resource request. The providing entity contribution data may be, for example, data describing the resource requests to which a providing entity is contributing (e.g. using the resource request ID), and the corresponding number of resources contributed, e.g. the third set of data described in method 200.

According to some embodiments, algorithm 300 may end when all qualified providing entities on the qualified list have been iterated over and contributions assigned to the resource request.

FIG. 4 is a flowchart depicting an algorithm 400, according to some embodiments of the invention, for dividing a resource request across the determined set of providing entities in accordance with the fairness criterion, as described in step 210 of method 200. The algorithm may only be used when a resource request is assessed and accepted, e.g. the algorithm may not be used where the resource request exceeds a total number of available resources among qualified providing entities (the resource request should be denied in such cases).

In some embodiments, the algorithm includes defining (402) R as a parameter describing the size of the request, e.g. the number of requested units in the resource request.

In some embodiments, the algorithm includes defining (404) N as a parameter describing the number of qualified providing entities in a list or set determined for example in step 208 of method 200.

In some embodiments, the algorithm includes include calculating (406) a contribution per entity C as C=R/N. This contribution may be a “naïve” application of the fairness criterion at this stage, equally dividing the size of the request among the number of qualified providing entities in the determined set. However, as discussed, not all qualified entities may have enough resources available to meet this contribution. The algorithm may adjust contributions on a per entity basis as is described in further detail below.

In some embodiments, the algorithm includes beginning to iterate (408) over a loop for each qualified providing entity in the list/set and query (410) if the available entity resources are less than C, e.g. if a number of units of resources associated with the entity being considered is sufficient to meet the contribution C.

If yes, and the number of resources available for allocation associated with the entity being considered is less than C, then in some embodiments the algorithm includes assigning (412) all of those available resources associated with the entity as that entity's contribution to the resource request. In some embodiments, the algorithm includes updating (414) the value of R as R=R−assigned resources, e.g. the size of the request R is updated to reflect that the entity has contributed resources to the request, thus reducing the size of the remaining request required to be fulfilled by the rest of the entities to be iterated over. In some embodiments, the algorithm includes removing (316) the entity from the list/set of qualified entities, effectively reducing N by 1 (e.g. updating N=N−1).

If the answer at step 410 is no, and the number of resources available for allocation associated with the entity being considered is greater than C, then in some embodiments, the algorithm includes assigning (418) the contribution C to that entity (e.g. the entity will contribute a number of resources equal to C). In some embodiments, the algorithm includes updating (420) the value of R as R=R−C.

In some embodiments, the following step from either step 416 or 420, e.g. depending on the decision branch taken at 410, is to query (422) if R=0, in other words has the resource request been fully fulfilled by the contributions from the qualified entities considered? If the answer is yes, the algorithm ends. If the answer is no, and R≠0, then embodiments may return to step 406 of the algorithm and determine a new contribution per entity C=R/N which may be affected by changes to R made at steps 414 and/or 420, as well as changes to N made at step 416.

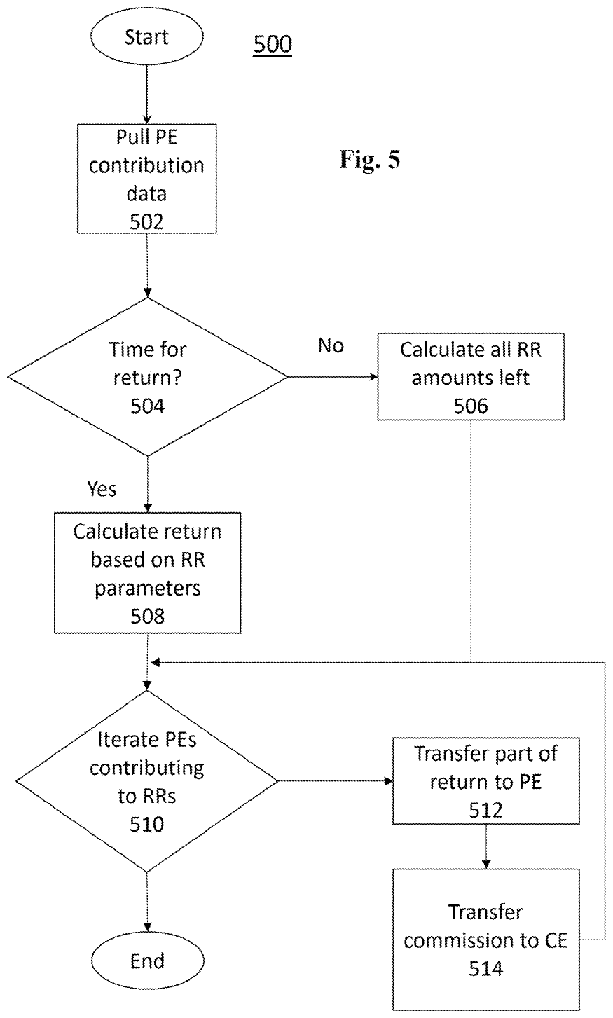

FIG. 5 is a flowchart depicting an algorithm 500. According to some embodiments, algorithm 500 distributes returns to providing entities. A return may be a return on a contribution to a resource request, and may be a return of the same type of resource as contributed to the request. For example, in embodiments where the resource is money, the return may also be money, and may, for example, represent an interest on the contributed/allocated amount. In embodiments where the resource is energy the return may represent, for example, an amount of electricity generated by solar panels given to the providing entity in exchange for fossil fuel generated electricity from the providing entity contributed at night.

According to some embodiments, algorithm 500 includes pulling (502) e.g. from a database such as storage 130, providing entity contribution data (such as is described above in relation to step 314 of FIG. 3).

According to some embodiments, algorithm 500 includes querying (504) if it is time for a return. A return frequency may be predefined (e.g. monthly) or may vary between providing entities based on at least one of resource type and/or predefined allocation criteria. For example, in embodiments where the resource is energy, returns may be transferred to the providing entity on a more frequent basis than in embodiments where the resource is money. The predefined allocation criteria may include a frequency with which the providing entity expects returns on their contribution of resources, e.g. hourly, daily, weekly, monthly, etc.

If the answer at 504 is no, and it is not time for a return, algorithm 500 may include calculating (506) all resource request amounts left.

If the answer at 504 is yes, and it is time for a return, algorithm 500 may include calculating (508) a return based on the resource request parameters. For example, the resource request parameters may include a return percentage, and algorithm 500 may calculate a return amount based on that percentage.

According to some embodiments, algorithm 500 may include iterating (510) on all providing entities contributing to resource requests.

According to some embodiments, algorithm 500 may include transferring (512) at least part of a resource request return to a providing entity. The amount transferred may be based on the predefined allocation criteria of the providing entity.

According to some embodiments, algorithm 500 may include transferring (514) a commission to the central entity (abbreviated “CE” in the Figure). The amount of the commission may be predefined, for example agreed upon between the providing entity and the central entity in a service agreement.

Algorithm 500 may end when all providing entities contributing to resource requests have been iterated over.

In some embodiments, a providing entity is able to withdraw their contribution in a resource request (or multiple resource requests or even all resource requests to which they are contributing) and transfer it to one or more different providing entities. For example, method 200 may include receiving, from a computing device of a providing entity contributing to a resource request, a seventh set of data describing a request to stop the allocation of its resources and take back the providing entity's contribution to the resource request. Method 200 may determine at least one new providing entity for which the resource request satisfies a set of predefined allocation criteria of the at least one new providing entity. Method 200 may then generate an eighth set of data describing a transfer of the contribution to the resource request from the withdrawing providing entity to the at least one new providing entity. In embodiments where the resource is money, withdrawing from a resource request may correspond to selling the loan to another party or parties. For example, the entity which is withdrawing may be a large entity which contributed a large number of resources to the resource request; it may be difficult to identify another single entity which can take on (e.g. match) such a contribution, and so instead the contribution to the resource request may be split among several smaller entities. The fairness criterion may determine how the contribution is to be split among the new providing entities.

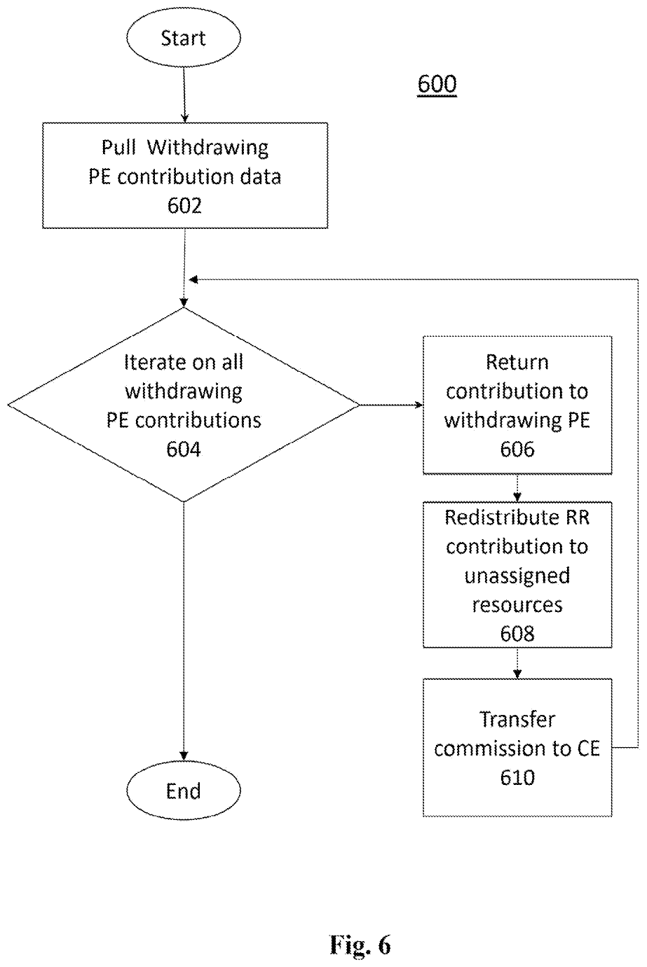

FIG. 6 is a flowchart depicting an algorithm 600. According to some embodiments, algorithm 600 assigns new providing entities to resource requests when a providing entity wishes to withdraw all their contributions to resource requests which they were involved in.

According to some embodiments, algorithm 600 includes pulling (602), e.g. from a database such as storage 130, contribution data for the withdrawing providing entity. The withdrawing providing entity contribution data may be as described at step 314 of FIG. 3.

According to some embodiments, algorithm 600 includes iterating (604) on all of the withdrawing providing entity's contributions, e.g. iterating on all resource requests to which the withdrawing providing entity is contributing.

According to some embodiments, algorithm 600 includes returning (606) the contribution to the providing entity. For example, if for a particular resource request the withdrawing providing entity contributed 10 units of the resource to that resource request then algorithm 600 may return 10 units of the resource to the withdrawing providing entity.

According to some embodiments, algorithm 600 includes redistributing (608) the resource request contribution to unassigned resources, e.g. identifying at least one other providing entity to contribute to the resource request. According to some embodiments, algorithms 300 and 400 may be used to determine new providing entities and divide the required contribution among them.

According to some embodiments, algorithm 600 may include transferring (610) a commission to the central entity.

Algorithm 600 may end when all of the resource requests to which the withdrawing providing entity was contributing to have been iterated over.

In some embodiments, any or all of algorithms 300, 400, 500 and/or 600 are executed by a processor, such as processor/controller 105 shown in FIG. 1.

In embodiments where the resource is seeds, the seeds may be handled by a device designed to handle seeds. Seeds may be stored in a central location, such as a seed bank. Physically storing the seeds in a central location may reduce a cost associated with sending a small resource such as seeds as compared to many individuals separately sending a small number (e.g. less than 10) to a requesting entity. A centralized seed bank may send, for example, 300 seeds in one package, whereas 300 providing entities each sending one seed would require 300 packages. A centralized seed bank may also help to ensure anonymity between providers and requestors.

FIG. 7 shows a system 700 according to some embodiments of the invention. System 300 may include a plurality of computing devices 710A, 710B, 710C, . . . , etc. associated with (e.g. operated by) a plurality of providing entities, or being themselves providing entities, a computing device 720 configured to perform embodiments of the present invention, and a plurality of computing devices 730A, 730B, 730C, . . . , etc. associated with (e.g. operated by) a plurality of requesting entities, or being themselves requesting entities.

Computing devices 710A, 710B, 710C, . . . , 720, and 730A, 730B, 730C, . . . , may be computing devices 100 shown in FIG. 1, and may be, for example, server computers. Computing devices 710A, 710B, 710C, . . . , and computing devices 730A, 730B, 730C, . . . , may communicate with computing device 720 over a communications network 740, such as the internet.

Computing device 720 may be referred to as a central load manager, or simply a load manager. Central load manager 720 may be configured to perform methods according to embodiments of the invention herein described, such as method 200 shown in FIG. 2. Alternately the operations of FIG. 1 may be performed by another entity, such as an entity sending or receiving goods according to a transfer. Load manager 720 may receive data from one or more of computing devices 710A, 710B, 710C, . . . , associated with a plurality of providing entities and/or a plurality of computing devices 730A, 730B, 730C, . . . , associated with a plurality of requesting entities.

For example, load manager 720 may receive a first set of data describing a plurality of providing entities and an associated first number of units of a resource which are available for allocation belonging to a corresponding providing entity, such as is described in method step 202 of method 200 described above.

Central load manager 720 may receive a second set of data from computing device 730A describing a resource request associated with a requesting entity, such as is described in method step 204 of method 200 described above. The resource request may include data describing a requested number of units of the resource.

Central load manager 720 may assess the resource request according to a set of predefined transfer or allocation criteria predefined for each of the plurality of providing entities, such as is described in method step 206 of method 200 described above. The predefined criteria may be received from each of computing devices 710A, 710B, 710C, . . . , etc. The set of predefined transfer or allocation criteria may include at least one of a: a geographic location of the requesting entity; a risk level of the requesting entity; an industry or other attribute of the requesting entity; and an allocation time period.

Central load manager 720 may determine a set of at least two providing entities for which the resource request satisfies the set of predefined allocation criteria of said at least two providing entities, such as is described in method step 208 of method 200 described above.

Central load manager 720 may divide the resource request across the determined set of providing entities in accordance with a fairness criterion, such as is described in method step 210 of method 200 described above.

Central load manager 720 may record or store, in a third set of data, a second number of units of the resource to be transferred from each of said at least two providing entities, such as is described in method step 212 of method 200 described above.

Central load manager 720 may send, to a computing device of the requesting entity (e.g. 730A, 730B, 730C, . . . , etc.), a fourth set of data describing a transfer of the requested number of units of the resource, such as is described in method step 214 of method 200 described above.

Central load manager 720 may receive, from the computing device of the requesting entity (e.g. 730A, 730B, 730C, . . . , etc.), at a predetermined time, a fifth set of data describing a third number of units to be distributed among the set of at least two providing entities, such as is described in method step 216 of method 200 described above.

Central load manager 720 may send, to a computing device of each providing entity (e.g. 710A, 710B, 710C, . . . , etc.) of the determined set of at least two providing entities, a sixth set of data describing a transfer of a fourth number of units of the resource in accordance with the set of predefined allocation criteria and the fairness criterion, such as is described in method step 218 of method 200 described above.

### Example 1

The following example shows how embodiments of the invention distribute the provided resources.

Table 1 shows a first set of data describing a plurality of providing entities and an associated first number of units of a resource which are available for allocation. Table 1 includes a plurality of providing entities A-F, the number of units of resource available for allocation, and several predefined allocation criteria including demographic requirements, a desired risk level of a requestor (e.g. a requesting entity), and return conditions for when the providing entity wants their resources to stop being allocated.

TABLE 1

| | Units of | | | |
|---|---|---|---|---|
| | Resource | | Desired Risk | |
| Providing | available for | Demographic | level of | Return |
| Entity | allocation | requirements | Requestor | conditions |
| A | 18 | Green | Low OR | April |
| | | | Moderate | |
| B | 10 | USA | Low | After March |
| C | 7 | USA Green | Low | April |
| D | 100 | Israel | High | After February |
| E | 1 | Ukraine | Moderate | In a year |
| F | 12 | Green | Low | After March |

Assume now that a requesting entity, R, submits a resource request for 36 units of computation to be used until April. Embodiments of the invention receive the resource request, and as part of data included in the resource request, R is described as being a Green industry based in the USA with a low level of risk.

Embodiments of the invention determine a set of at least two providing entities for which the resource request satisfies the set of predefined allocation criteria of the at least two providing entities. The determined set of relevant providing entities is the set A, B, C, and F.

Embodiments of the invention divide the resource request across the determined set of providing entities in accordance with a fairness criterion. Assuming the fairness criterion is an even split, then the requested number of units (36) is divided by 4 (for four relevant providing entities A, B, C, and F). Thus, each providing entity is to contribute 9 units of resource to the resource request. However, providing entity C does not have 9 units of resource available to allocate, only having provided data describing 7 units available to allocate. Therefore, embodiments of the invention determine that providing entity C will contribute all 7 of its available units, and the remaining providing entities of the determined set (A, B, and F) will each provide 9 and a third units of resource (this works assuming units can be sub-divided; when they cannot the process used is described further below). This difference will be stored or recorded and used for future resource requests, so that the fairness criterion applies at a macro, or global, level and not just on a per contract basis.

Assuming, as in other embodiments, that the fairness criterion relates to a proportional contribution, then the set of determined providing entities can provide at most 18+10+7+12=47 units of the resource. Thus, in a proportional scheme, each providing entity contributes

$$\frac{36}{47} * ( available units ) ,$$

and so A contributes 36/47*18=13.787, B contributes 36/47*10=7.660, C contributes 36/47*7=5.361, and F contributes 36/47*12=9.191. This works assuming that units of the resource can be sub-divided. If they cannot, and full units must be used, then the contributions are rounded to the nearest whole unit and the differences in contribution are recorded or stored for later use so that the fairness criterion applies at a macro, or global, level and not just on a per contract basis.

Assuming that the contributions from the providing entities must be in whole numbers of units of the resource (such as with seeds), then in the case of an even split, C contributes all 7 of its resources, B may contribute 9 and A and F may contribute 10, for a total of 36 units, as requested by R. In the case of proportional contribution, then A may be determined to contribute 14 units, B may be determined to contribute 7 units, C may be determined to contribute 6 units and F may be determined to contribute 9 units. It will be understood that different divisions among the determined relevant providing entities are possible (e.g. A: 13, B: 8, C: 5, and F: 10) and may be determined based on past resource request contributions so as to take into account a global level of fairness across multiple resource requests. The differences in contribution may be recorded and taken into account for subsequent resource requests so that fairness applies over more than one contract.

In every instance as described in Example 1 above none of providing entities A, B, C, or F may be aware of the identity of R, and vice versa. Similarly, none of A, B, C, or F may be aware of one another. Only a central computing device, such as a load manager 720 shown in FIG. 7, may be aware of the identities of the entities (e.g. providing and requesting) and the contracts (e.g. resource requests) that they are involved in. In this way, embodiments of the invention provide an anonymized and centralized method of transfer or allocation of resources.

Embodiments of the invention may improve the technology of computer usage, allowing for more efficient use of computer resources such as memory, processing bandwidth, network bandwidth, etc. Embodiments may improve the technologies of resource usage and allocation and improve the utilization of otherwise under-utilized resources, such as unused computer resources. For example, embodiments of the invention may receive a number of units of a computing resource which are available for allocation, and may allocate the computing resources in a way which best utilizes the available resources, such as by considering an industry or other attribute of the entity to which the resources may be allocated.

Unless specifically stated otherwise, as apparent from the foregoing discussion, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may include an article such as a computer or processor readable non-transitory storage medium, such as for example a memory, a disk drive, or a USB flash memory encoding, including, or storing instructions, e.g., computer-executable instructions, which when executed by a processor or controller, cause the processor or controller to carry out methods disclosed herein.

It should be recognized that embodiments of the invention may solve one or more of the objectives and/or challenges described in the background, and that embodiments of the invention need not meet every one of the above objectives and/or challenges to come within the scope of the present invention. While certain features of the invention have been particularly illustrated and described herein, many modifications, substitutions, changes, and equivalents may occur to those of ordinary skill in the art. It is, therefore, to be understood that the appended claims are intended to cover all such modifications and changes in form and details as fall within the true spirit of the invention.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures, and examples.

It is to be understood that the details set forth herein do not construe a limitation to an application of the invention.

Furthermore, it is to be understood that the invention may be carried out or practiced in various ways and that the invention may be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not to be construed that there is only one of that element.

It is to be understood that where the specification states that a component, feature, structure, or characteristic “may”, “might”, “may” or “could” be included, that a particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A computer implemented method of centralized allocation of resources comprising:
receiving a first set of data describing a plurality of providing entities and an associated first number of units of a resource which are available for allocation belonging to a corresponding providing entity;
receiving a second set of data describing a resource request associated with a requesting entity, wherein the resource request comprises a requested number of units of the resource;
assessing the resource request according to a set of predefined allocation criteria predefined for each of the plurality of providing entities,
wherein the set of predefined allocation criteria comprises at least one of: a geographic location of the requesting entity; a risk level of the requesting entity; an industry or other attribute of the requesting entity; and an allocation time period;
determining a set of at least two providing entities for which the resource request satisfies the set of predefined allocation criteria of said at least two providing entities;
dividing the resource request across the determined set of providing entities in accordance with a fairness criterion;
recording, in a third set of data, a second number of units of the resource to be transferred from each of said at least two providing entities;
sending, to a computing device of the requesting entity, a fourth set of data describing a transfer of the requested number of units of the resource;
receiving, from the computing device of the requesting entity, at a predetermined time, a fifth set of data describing a third number of units of the resource to be distributed among the set of at least two providing entities; and
sending, to a computing device of each providing entity of the determined set of at least two providing entities, a sixth set of data describing a transfer of a fourth number of units of the resource in accordance with the set of predefined allocation criteria and the fairness criterion.

2. The method of claim 1, wherein neither the at least two providing entities contributing to the resource request, nor the requesting entity from which the resource request was received are aware of the involvement of any of the other entities in the resource request.

3. The method of claim 1, wherein a same providing entity contributes units of the resource to more than one resource request.

4. The method of claim 3, wherein the fairness criterion takes into account at least one of: an attribute of the providing entity; or one or more previous contributions of the providing entity to one or more previous resource requests.

5. The method of claim 1, wherein the resource is one of computer resources, seeds, energy, or money.

6. The method of claim 1, comprising receiving, from a computing device of a providing entity contributing to a resource request, a seventh set of data describing a request to stop and take back the allocation of the providing entity's contribution to the resource request;
determining at least one new providing entity for which the resource request satisfies a set of predefined allocation criteria of the at least one new providing entity; and
generating an eighth set of data describing a transfer of the contribution to the resource request from the withdrawing providing entity to the at least one new providing entity.

7. A system for centralized allocation of resources comprising:
at least one processor; and
a memory containing one or more sets of instructions which, when executed, cause the at least one processor to:
receive a first set of data describing a plurality of providing entities and an associated first number of units of a resource which are available for allocation belonging to a corresponding providing entity;
receive a second set of data describing a resource request associated with a requesting entity, wherein the resource request comprises a requested number of units of the resource;
assess the resource request according to a set of predefined allocation criteria predefined for each of the plurality of providing entities,
wherein the set of predefined allocation criteria comprises at least one of a: a geographic location of the requesting entity; a risk level of the requesting entity; an industry or other attribute of the requesting entity; and an allocation time period;
determine a set of at least two providing entities for which the resource request satisfies the set of predefined allocation criteria of said at least two providing entities;
divide the resource request across the determined set of providing entities in accordance with a fairness criterion;
record, in a third set of data, a second number of units of the resource to be transferred from each of said at least two providing entities;
send, to a computing device of the requesting entity, a fourth set of data describing a transfer of the requested number of units of the resource;
receive, from the computing device of the requesting entity, at a predetermined time, a fifth set of data describing a third number of units of the resource to be distributed among the set of at least two providing entities; and
send, to a computing device of each providing entity of the determined set of at least two providing entities, a sixth set of data describing a transfer of a fourth number of units of the resource in accordance with the set of predefined allocation criteria and the fairness criterion.

8. The system of claim 7, wherein the processor is configured to ensure that neither the at least two providing entities contributing to the resource request, nor the requesting entity from which the resource request was received are aware of the involvement of any of the other entities in the resource request.

9. The system of claim 7, wherein the processor is configured to record when a same providing entity contributes units of the resource to more than one resource request.

10. The system of claim 9, wherein the fairness criterion takes into account at least one of: an attribute of the providing entity; or one or more previous contributions of the providing entity to one or more previous resource requests.

11. The system of claim 7, wherein the resource is one of computer resources, seeds, energy, or money.

12. The system of claim 7, wherein the processor is configured to:
receive, from a computing device of a providing entity contributing to a resource request, a seventh set of data describing a request to stop and take back the allocation of the providing entity's contribution to the resource request;
determine at least one new providing entity for which the resource request satisfies a set of predefined allocation criteria of the at least one new providing entity; and
generate an eighth set of data describing a transfer of the contribution to the resource request from the withdrawing providing entity to the at least one new providing entity.

13. A computer implemented method of transfer of assets comprising:
receiving a plurality of first data sets, each first data set describing a providing entity and an associated first number of assets which are available for transfer;
receiving a second set of data describing a request associated with a requesting entity, wherein the request comprises a requested number of assets;
identifying at least two providing entities for which the request satisfies a set of predefined transfer criteria selected by said at least two providing entities;
dividing the request across the identified at least two providing entities equally, or according to the first number of assets of each of said at least two providing entities;
recording, in a third set of data, a second number of assets to be transferred from each of said at least two providing entities; and
sending, to a computing device of the requesting entity, a fourth set of data describing a transfer of the requested number of assets.

14. The method of claim 13, comprising:
receiving, from the computing device of the requesting entity, at a predetermined time, a fifth set of data describing a third number of assets to be distributed among the identified at least two providing entities; and
sending, to a computing device of each of said identified at least two providing entities, a sixth set of data describing a transfer of a fourth number of assets in accordance with the set of predefined allocation criteria and the fairness criterion.

15. The method of claim 13, wherein neither the identified at least two providing entities, nor the requesting entity from which the request was received are aware of the involvement of any of the other entities in the request.

16. The method of claim 13, wherein a same providing entity contributes a number of assets to more than one request.

17. The method of claim 13, wherein the set of transfer criteria comprises at least one of: a geographic location of the requesting entity; a risk level of the requesting entity; an industry or other attribute of the requesting entity; and a predetermined time period after which the assets are to be transferred back.

18. The method of claim 13, wherein dividing the request across the identified at least two providing entities according to the first number of assets of each of said at least two providing entities takes into account at least one of: an attribute of the providing entity; or one or more previous contributions of the providing entity to one or more previous requests.

19. The method of claim 13, wherein the asset is one of computer resources, seeds, energy, or money.

20. The method of claim 13, comprising receiving, from a computing device of a providing entity contributing to a request, a seventh set of data describing a request to stop and take back the transfer of the providing entity's contribution to the resource request;
determining at least one new providing entity for which the request satisfies a set of predefined transfer criteria of the at least one new providing entity; and
generating an eighth set of data describing a transfer of the contribution to the request from the withdrawing providing entity to the at least one new providing entity.
